(19) United States
(12) Patent Application Publication
(10) Pub. No.: US 2025/0311736 A1
(43) Pub. Date: Oct. 9, 2025

(54) SEED TREATMENT METHODS FOR INCREASING YIELD IN CROP PLANTS

(71) Applicant: BAYER AKTIENGESELLSCHAFT, Leverkusen (DE)

(72) Inventors: Marc ANDRIEUX, Düsseldorf (DE); Pierre GRANDJEAN, Tassin-la-demi-lune (FR); Michael Agostinos KLÜKEN, Krefeld (DE); Bénédicte LABORIE, Chasselay (FR); Marc André RIST, Düsseldorf (DE); Florent TARROUX, Lavaur (FR)

(21) Appl. No.: 18/724,284

(22) PCT Filed: Dec. 21, 2022
(86) PCT No.: PCT/EP2022/087312

§ 371 Date: Jun. 26, 2024

(30) Foreign Application Priority Data
Dec. 28, 2021 (EP) 21218013.7

(51) Int. Cl. A01N 65/08; A01P 21/00

(52) U.S. Cl. CPC A01N 65/08; A01P 21/00

(57) ABSTRACT

Provided herein are seed treatment methods that are useful for increasing the yield of crop plants. More specifically, the method comprises treating the seeds of the crop plants with a composition comprising an extract of a pepper plant of the genus Piper.

### FIELD

Provided herein are seed treatment methods that are useful for increasing the yield of crop plants. More specifically, the method comprises treating the seeds of the crop plants with a composition comprising an extract of a pepper plant of the genus Piper.

### BACKGROUND

Yield is the most important point of attention of crop growers. The more yield growers get from the crop they grow, the more revenues they can obtain by selling their harvest.

However, from the time the seeds of a crop are planted or sown to the time the crop is harvested, the yield may be negatively affected by many biotic or abiotic factors. Among the biotic factors are plant pathogens infecting the crop, insects feeding on it, or weeds competing for resources. Among the abiotic factors, one can cite drought as the one most often seen, but excess wind is another example.

Breeders also try to develop new crop varieties having a potential of higher yield, be it because they would be resistant to certain pathogens, or because they have a better capacity to uptake water and nutrients, or because they are able to produce more harvestable material (e.g. grains) per plant.

Crop protection products, be they chemical or biological, are also available for growers to assist them in trying to control most biotic factors affecting the crop, in the form of e.g. fungicides, insecticides or herbicides.

In order to maximize yield, growers have to make many important choices all over the growth of the crop they have chosen to grow in a given field, from the choice of the most adapted variety to the use of proper fertilizers and the appropriate use of crop protection products when necessary. Certain of these products are required to be applied during the growth phase of the crop, but some are already directly applied to the seed in the form of a seed coating in order to protect the germination and first steps of growth from soil pests and pathogens.

Certain products are also known to stimulate the growth of certain plants or to stimulate their natural defense mechanisms, but there exists only a few of such products, and there is therefore a need for additional products that could have the capacity to increase the yield of a crop, preferably products that would have a biological origin.

The inventors have surprisingly found that an extract of the pepper plant of the genus Piper, more particularly an extract of the black pepper plant Piper nigrum, has the capacity of increasing the yield of crops grown in a field. Moreover, the inventors have shown that this increase in the yield can be obtained by treating only the seeds, or any relevant plant propagation material, that are planted or sown for growing the crop, with such an extract of pepper plant.

Extracts of the pepper plant of the genus Piper were already known to have an effect of bird repellency when applied to seeds or any relevant plant propagation material, though without being toxic to such seed or such other relevant plant propagation material (WO2020/169761). Extracts of the pepper plant of the genus Piper were however not known to possibly increase the yield of crops, independently of any attacks from birds.

This effect is the more so surprising that some compounds of pepper plant of the genus Piper, including the most known of them, piperine, are known to rather have a phytotoxic effect on plants, i.e. an effect that inhibits their growth (Tavares et al., 2011, J. Med. Plant Res. 5 (21), 5301-5306; Suwitchayanon et al., 2019, Acta Physiologiae Plantarum 41 (3), 33).

### SUMMARY

One aspect of the present invention is a method for increasing the yield of crop plants, characterized in that the plant propagation material from which such plant is being grown is treated, or covered, or coated, or dressed, or overspread, or overlaid, with a composition comprising an extract of a pepper plant of the genus Piper.

According to a certain embodiment, the composition is a composition comprising an extract of a pepper plant of the genus Piper, more specifically an extract of the plant Piper nigrum, even more specifically an extract of the fruits of the plant Piper nigrum.

According to a particular aspect of the invention, the plant extract comprised in the composition is an oleoresin.

The method is generally directed to a plant propagation material, and it is more specifically suitable to a seed as plant propagation material. Alternatively, it is also suitable to any plant part for vegetative propagation.

According to a certain embodiment, the method according to the invention comprises a step of planting or sowing at least one plant propagation material of the crop plant, whereby such plant propagation material is treated, or covered, or coated, or dressed, or overspread, or overlaid, with a composition comprising an extract of a pepper plant of the genus Piper.

According to a further embodiment, the method according to the invention comprises a step of growing the crop plant until maturity of its harvestable plant material.

The method according to the invention may be carried out in an open field. It may also be carried out in a greenhouse, a glasshouse or any building suitable for growing crops. It may also be carried out with a crop plant grown in hydroponic conditions.

According to the present method, the increase in yield is comprised between 1% and 20%. Alternatively, the increase in yield is comprised between 1% and 10%. Further alternatively, the increase in yield is at least 5%.

According to a certain embodiment, the method is implemented on a plant propagation material treated, or covered, or coated, or dressed, or overspread, or overlaid, with a composition comprising the compound piperine.

### DETAILED DESCRIPTION

One aspect of the present disclosure is directed to a method for increasing the yield of crop plants, characterized in that the plant propagation material is being treated, or covered, or coated, or dressed, or overspread, or overlaid, with a composition comprising an extract of a pepper plant of the genus Piper.

According to a certain embodiment, the method according to the invention comprises a step of planting or sowing at least one plant propagation material of the crop plants in a field, whereby such plant propagation material is treated, or covered, or coated, or dressed, or overspread, or overlaid, with a composition comprising an extract of a pepper plant of the genus Piper.

According to a certain embodiment, the method according to the invention comprises a step of growing the crop plant until maturity of its harvestable plant material.

In the context of the invention, the yield is intended to mean the quantity of harvestable plant material per growing surface area, i.e. such surface area where the crop plant is grown. The nature of the harvestable plant material depends on the crop grown, and can either be seeds, fruits, roots, leaves, stalks or any other part of the crop for which it is grown. According to one aspect, the harvestable plant material is the seed or grain. The quantity of harvestable plant material is usually reported as a weight of harvestable plant material, and the yield is usually reported as this weight of harvestable plant material per growing surface area. A preferred growing surface area for expressing yield is the hectare (ha) in countries using the metric system or the acre (ac) in the other countries. Given the size of this surface, the usual unit for expressing the quantity of harvestable plant material is usually the tonne (t). A usual unit for reporting the yield of crops is therefore tonnes per hectares, i.e. t/ha.

According to the invention, the yield of the crop plant grown in a field is increased. An increase in yield is usually expressed in percentage (%) of gain of quantity of harvestable plant material per surface area. Increases in the yield of crop plants usually represent low percentage numbers, but these low percentage numbers represent much in terms of quantity of harvestable plant material produced and hence of value for the growers, because of the large surfaces grown. As an example, an increase in 1% of yield for a given crop is yet seen as a very valuable increase for a grower. An increase of yield according to the invention is therefore at least 1%, at least 2%, at least 3%, at least 4%, at least 5%, at least 6%, at least 7%, at least 8%, at least 9%, at least 10%, at least 15%, or at least 20%. Because of the many factors influencing yield and the minor variations that these factors can have on yield, the effect of the invention on yield increase may slightly vary depending on the occurrence of such factors. The increase of yield according to the invention can therefore also be expressed as being about 1%, about 2%, about 3%, about 4%, about 5%, about 6%, about 7%, about 8%, about 9%, about 10%, about 15%, or about 20%. An increase of yield according to the invention is also expressed as being comprised between 1% and 20%, between 1% and 15%, between 1% and 10%, between 1% and 9%, between 1% and 8%, between 1% and 7%, between 1% and 6%, between 1% and 5%, between 1% and 4%, between 1% and 3%, between 1% and 2%.

The increase of yield resulting from carrying out the method according to the invention is an effect of the composition comprising an extract of a pepper plant of the genus Piper that is independent from the bird repellent effect of such composition. It is therefore an increase of yield not resulting from a possible decrease of attacks of the plant propagation material or the plantlets and plants growing therefrom by birds.

The increase of yield resulting from carrying out the method according to the invention is an effect of the composition comprising an extract of a pepper plant of the genus Piper that is also independent from a possible insecticidal, fungicidal or herbicidal effect of such composition. It is therefore an increase of yield not resulting from a possible decrease of infestation of the plant propagation material or the plantlets and plants growing therefrom by insects or fungal pathogens or from a possible decrease of competition in the field with weeds.

Yield is a resulting outcome that can be due to many underlying factors. An increase of yield according to the invention may therefore be due to an underlying effect of the composition comprising an extract of a pepper plant of the genus Piper on some of the plant growth parameters that eventually play a role in increasing the quantity of harvestable plant material of a given plant. The observed effect of increase of yield may therefore also be expressed by a variety of such underlying effects having a role in increasing the quantity of harvestable plant material of a given plant. For example, the effect of increasing the yield of the crop plants may also be expressed as an effect of stimulating the growth of the crop plants. It may also be expressed as an effect of increasing the development of roots of the crop plants, or an effect of stimulating the uptake of water or nutrients of the crop plants, or an effect of increasing the photosynthetic capacity of the crop plants, or an effect of increasing the development of tillers or leaves of the crop plants.

Since the yield of a crop plant is reported as a quantity of harvestable plant material per surface area, yield is usually measured once such harvestable plant material has been harvested, i.e. at a time when the crop plant has reached optimal maturity of such harvestable plant material to be actually harvested.

Accordingly, the method according to the invention comprises a step of planting or sowing at least one plant propagation material of a crop plant in a field and then growing the crop plant until maturity of the harvestable plant material. The term “plant propagation material” includes all sexually-produced material (seeds and fruits) and asexually-produced material (plant parts for vegetative propagation), depending on the relevant material to be planted/sown for a given crop. The method according to the invention involves a step of planting or sowing at least one plant propagation material of a crop plant in a field. The planting or sowing methods depend on the type of plant propagation material, and a person skilled in the art knows which planting or sowing method is most adapted for which type of plant propagation material. The field can be an open field, or any surface covered with a glasshouse or greenhouse. It can also be any building suitable for growing crops. Moreover, the plant propagation material may be planted or sown in soil but also in any substrate that is suitable for growing crop plants, or in hydroponic conditions. Accordingly, the plant propagation material may also be planted or sown in pots or any pot-like structures. In order to assess the yield increase provided by the invention, the method also involves a step of growing the crop plant until maturity of the harvestable plant material. This step depends on the nature of the crop and its relevant harvestable plant material, and the skilled person knows, depending on the crop and its harvestable plant material, what is the appropriate time when maturity is reached for the crop to be harvested.

The important finding of the inventors for properly carrying out the method according to the invention is that the plant propagation material shall be treated, or covered, or coated, or dressed, or overspread, or overlaid, with a composition comprising an extract of a pepper plant of the genus Piper. In order to be performed, the method does not require any additional treatment with the composition comprising an extract of a pepper plant of the genus Piper during the step of growing the crop plant until maturity of the harvestable plant material, i.e. the only treatment required for increasing the yield of the crop plant is on the plant propagation material that is being planted or sown. Additional treatments with the composition may be performed, but they are not necessary for the method to be carried out and the increase of the yield of the crop plant to be observed.

In the context of the present invention, the term “treated” is intended to mean that a process of application of the composition on the plant propagation material is performed, and that the resulting plant propagation material is actually covered, or, in a synonymous meaning, coated, dressed, overspread, or overlaid, with such composition.

In the context of the present invention, and not differently than the conventional meaning of this term, an “extract” is intended to mean a composition that is obtained by applying a chemical or mechanical process to a given biological material or a part thereof, and that does not contain the complete chemical constituents of the starting material being subject to extraction. In this meaning, an “extract” is not a material that has all the constituents of the starting material being subject to extraction, that are put in a different shape, i.e. an extract is not a material that is simply ground or powdered. An extract is also not a mere physical part of the material to be extracted, e.g. the leaves or the seeds of a complete plant. An extract is therefore a chemical portion of the starting material being subject to extraction, i.e. in the context of the invention, a chemical portion of a pepper plant of the genus Piper or only of a part thereof. A similar way to designate an extract is, for example, an “extracted chemical portion”.

According to one aspect, the plant extract is a solvent extract, i.e. the whole plant or only a certain part of the plant is put into contact with a solvent so as to extract certain components of the plant in the solvent. The solvent used for the extraction may be any non-aqueous, organic solvent, for example, ethanol, acetone, ether, dichloroethane, ethyl acetate or hexane. Preferably, the solvent used is a combination of solvents comprising ethyl acetate, acetone and hexane. The extraction may be repeated several times in order to extract most of the extractable components. After solvent extraction, the solvents may be removed, e.g. by evaporation, thereby yielding a semi-solid extract usually qualified in the relevant art as a resin.

A preferred type of plant extract according to the invention is an extract known as oleoresin. An oleoresin is a combination of two types of extracts: (i) a solvent-extracted resin as described above, and (ii) a distillate obtained by steam distillation. According to this embodiment, the plant extract according to the invention is an oleoresin comprising a solvent-extracted resin of the plant and a distillate obtained from steam distillation of the plant. According to a specific embodiment, the solvent extract and the steam-distilled extract are both obtained from a same plant material, i.e. the parts of the plant used for extraction are first subjected to steam distillation, from which the distillate component is obtained, and then these same parts of the plant used for steam distillation are, in a second step, subjected to a solvent extraction, from which the resin component is obtained. Alternatively, the distillate component and the resin component can be obtained from different batches of plant material. Both the distillate component and the resin component are then combined together to form the oleoresin.

Oleoresins may contain various proportions of the distillate component and of the resin component so as to obtain oleoresins of various compositions and properties. Oleoresins can also contain additional components that are not plant extracts. Such additional components can, for example, be propylene glycol, triacetin or any other additives that are known to facilitate the mixing of the distillate and resin components and hence improve the properties of the oleoresin.

Accordingly, the plant extract according to the invention is a composition comprising a solvent-extracted resin, i.e. it is either the solvent-extracted resin itself or an oleoresin.

According to a particular embodiment, the plant propagation material is treated, or covered, or coated, or dressed, or overspread, or overlaid, with a composition comprising an extract of plants of the genus Piper. This may include for example the species Piper nigrum or Piper longum. A preferred species of Piper for carrying out the invention is Piper nigrum. This includes the many cultivars and varieties of the species Piper nigrum.

Any parts of the plant of the genus Piper may be used for carrying out the invention. According to one aspect of the invention, the plant propagation material is treated with a composition comprising an extract of fruits of the black pepper plant Piper nigrum.

According to the invention, the extract of the black pepper plant Piper nigrum is an extract containing piperine, a compound naturally present in several species of the genus Piper, most notably in the black pepper plant Piper nigrum. Accordingly, the extract is obtained by any means that is able to extract at least piperine. There are many known methods of extraction, such as those described in Gorgani et al. (2017), Comprehensive Reviews in Food Science and Food Safety 16:124-140. According to one embodiment, the extract is a solvent extract. The solvent used for the extraction may be any non-aqueous, organic solvent, for example, ethanol, acetone, ether, dichloroethane, ethyl acetate or hexane. Preferably, the solvent used is a combination of solvents comprising ethyl acetate, acetone and hexane. The extraction may be repeated several time in order to extract most of the extractable component. After solvent extraction, solvents may be removed, e.g. by evaporation, thereby yielding a semi-solid extract qualified as resin.

A preferred type of extract according to the invention is an oleoresin, comprising a mixture of a steam distillate of the black pepper plant Piper nigrum and a solvent-extracted resin of the black pepper plant Piper nigrum.

A particular aspect of the present disclosure is therefore directed to a method for increasing the yield of crop plants grown in a field, comprising a step of planting or sowing at least one plant propagation material of said crop plants in said field and a step of growing the crop plant until maturity of the harvestable plant material, characterized in that the plant propagation material is being treated, or covered, or coated, or dressed, or overspread, or overlaid, with an oleoresin of fruits of the black pepper plant Piper nigrum.

Black pepper solvent extracts, or compositions comprising such extracts like oleoresins, contain the compound piperine (Gorgani et al., 2017, Comprehensive Reviews in Food Science and Food Safety, Vol. 16:124-140).

Oleoresins of black pepper Piper nigrum may contain various proportions of the distillate component and of the resin component so as to obtain an oleoresin with desired quantities of piperine. Oleoresins may contain from 10% to 60% of piperine. Depending on the requirements, oleoresins with various quantities of piperine can be obtained by mixing appropriate quantities of the resin and the distillate, and dosing the piperine in the oleoresin. Piperine content can be measured using a standard protocol, more particularly by measuring absorbance after extraction in ethanol, at a maximal absorbance of 342-345 nm under exposure by a UV light source. Oleoresins may contain at least or about 10%, 15%, 20%, 25%, 30%, 35%, 40%, 45%, 50%, 55%, 60% of piperine. According to a specific embodiment, an oleoresin of black pepper Piper nigrum comprises 38% of piperine. Oleoresins may also contain various proportions of volatile oils depending on the quantity of distillate introduced for its preparation.

The invention may also be carried out with chemically-synthesized piperine (Olsen and Spessard, 1981, J. Agric. Food Chem. 29:942-944). Accordingly, the invention may also be carried out with a plant propagation material treated, or covered, or coated, or dressed, or overspread, or overlaid, with piperine.

A preferred source for the extract of plants of the genus Piper is the fruit of such plants, most particularly the fruits of the black pepper plant Piper nigrum. The fruits of the black pepper plant Piper nigrum from which the extract is obtained may be in any form, i.e. fresh or dried fruits, ripe or unripe, cooked or uncooked. Preferably, the fruits of the black pepper plant Piper nigrum from which the extract is obtained are in the form of cooked and dried unripe fruits. In order to improve the extraction process, the fruits are crushed before being subject to steam distillation and/or put in contact with one or more solvent.

The extract of plants of the genus Piper is also one that does not naturally contain an effective amount of the compound anthraquinone.

The inventors have found out that plant propagation materials, in particular seeds, that are treated, or covered, or coated, or dressed, or overspread, or overlaid, with a composition comprising an extract of fruits of the black pepper plant Piper nigrum, grow into plants that have an increased yield of their harvestable plant material. Although the yield increase of the harvestable plant material may not be measurable on a single plant, it is measurable, like any yield comparisons made by crop growers, over a certain surface on which several plants are grown, e.g. a surface area of at least a hundred square meters, preferably over a field of at least one hectare.

One important advantage of the compositions according to the invention is that they are safe to plant propagation materials, in particular to seeds. Safe to plant propagation materials, in particular seeds, in the context of the present invention means that the capacity of such plant propagation materials or seeds to germinate and to grow a fully fertile plants is not affected by the treatment, covering, coating, dressing, overlay, or overspray, of such plant propagation materials or seeds with the compositions of the invention.

In the case of seeds, but this is generally also true for other types of plant propagation materials, the natural capacity to germinate and to grow fully fertile plants is generally variable among the seeds of a same plant species or even plant variety. This is due to the fact that a certain small percentage of non-viable seeds are systematically produced by plants. In the seeds production industry, this may also be due to certain damages caused to some seeds during the various processing steps of the seeds in the process of seed production. Usually, that percentage of non-viable seeds is low, i.e. in the range of less than 5 percent. It may however be different, ideally lower but sometimes higher, depending on the type of plant or plant variety from which the seeds are produced, but also on the quality of the seed production process. The capacity of seeds to germinate and to grow fully fertile plants is therefore to be understood as referring to an average capacity assessed on several seeds, preferably at least 10 seeds, but more preferably 50 or 100 seeds.

Accordingly, the treated, or covered, or coated, or dressed, or overspread, or overlaid, plant propagation material, in particular the treated, or covered, or coated, or dressed, or overspread, or overlaid, seeds, according to the invention are plant propagation materials or seeds whose capacity to germinate and to grow a fully fertile plant is not significantly affected by their treatment, covering, coating, dressing, overlay, overspray, with the compositions of the invention.

The seeds according to the invention may be any seeds from any plants and the method could be applied to any plant. Preferably, the seeds according to the invention are seeds of crop plants, i.e. seeds of cultivated plants.

Many crop plants are not cultivated from a seed, but rather by vegetative propagation. Vegetative propagation is a form of plant reproduction that does not involve sexual crossing, but that makes use of the capacity of certain plants to grow a new plant from a part of a parent plant. Such part of the parent plant may be any part depending on the plant concerned. It may also be a specialized reproductive organ in certain plants. Specialized reproductive organ from which a new plant can grow can be rhizomes, tubers, bulbs, runners, corms or suckers. Examples of crop plants growing from such organs are potatoes (tubers), onions, garlic, shallots (bulbs), apple trees, cherry trees, banana trees (suckers). Parts of plants that can be used as planting material to grow new plants may be stem or leaf cuttings. Example of a crop plant that can grow from cuttings is sugarcane (stem cuttings).

Overall, the method according to the invention can be performed whereby the composition is applied on various types of plant parts used for the reproduction of new plants. These plant parts include the seeds and fruits, but also all vegetative propagation parts of the plants. For the purpose of the present invention, all these plant parts can be covered under the term “plant propagation material” or “plant reproduction material”, which therefore includes all sexually-produced material (seeds and fruits) and asexually-produced material (plant parts for vegetative propagation).

According to a particular embodiment, the plant propagation material is a seed. According to another embodiment, the plant propagation material is a plant part for vegetative reproduction. Plant propagation material, be it seeds or any plant part for vegetative reproduction, according to the invention is a plant propagation material that is viable, in the sense that it can be planted/sown and grown into a fertile plant. The plant propagation material according to the invention is therefore not one that has been prepared for food or feed purposes, i.e. not one that has for example been fermented, cooked or roasted. Accordingly, the plant propagation material of the invention is a viable, unfermented, uncooked or unroasted plant propagation material. It can therefore also be characterized as plant propagation material, with the exception of plant propagation material that is prepared for food or feed purposes, or alternatively, with the exception of plant propagation material that has been fermented, cooked or roasted.

Crop plants to which the method according to the invention can be applied may be plants which can be obtained by conventional breeding and optimization methods or by biotechnological, genetic engineering, or gene editing methods or combinations of these methods, including genetically modified plants (GMO or transgenic plants) and plant cultivars or varieties which are protectable and non-protectable by plant breeders' rights.

Genetically modified plants (GMO or transgenic plants) are plants in which a heterologous gene has been stably integrated into the genome. The expression “heterologous gene” essentially means a gene which is provided or assembled outside the plant and when introduced in the nuclear, chloroplastic or mitochondrial genome. This gene gives the transformed plant new or improved agronomic or other properties by expressing a protein or polypeptide of interest or by downregulating or silencing other gene(s) which are present in the plant (using for example, antisense technology, cosuppression technology, RNA interference-RNAi-technology or microRNA-miRNA-technology). A heterologous gene that is located in the genome is also called a transgene. A transgene that is defined by its particular location in the plant genome is called a transformation or transgenic event.

Seeds or plant propagation materials of crop plants which may be treated, or covered, or coated, or dressed, or overspread, or overlaid, in accordance with the compositions of the invention include seeds or plant propagation materials of the following: cotton, flax, grapevine, fruit, vegetables, such as Rosaceae sp. (for example pome fruits such as apples and pears, but also stone fruits such as apricots, cherries, almonds and peaches, and soft fruits such as strawberries), Ribesioidae sp., Juglandaceae sp., Betulaceae sp., Anacardiaceae sp., Fagaceae sp., Moraceae sp., Oleaceae sp., Actinidaceae sp., Lauraceae sp., Musaceae sp. (for example banana trees and plantations), Rubiaceae sp. (for example coffee), Theaceae sp., Sterculiceae sp., Rutaceae sp. (for example lemons, oranges and grapefruit); Solanaceae sp. (for example tomatoes), Liliaceae sp., Asteraceae sp. (for example lettuce), Umbelliferae sp., Cruciferae sp., Chenopodiaceae sp., Cucurbitaceae sp. (for example cucumber), Alliaceae sp. (for example leek, onion); major crop plants, such as Gramineae sp. (for example maize, turf, cereals such as wheat, rye, rice, barley, oats, millet and triticale), Asteraceae sp. (for example sunflower), Brassicaceae sp. (for example white cabbage, red cabbage, broccoli, cauliflower, Brussels sprouts, pak choi, kohlrabi, radishes, and oilseed rape, mustard, horseradish and cress), Fabacae sp. (for example peas, beans, peanuts), Papilionaceae sp. (for example soya bean), Solanaceae sp. (for example potatoes), Chenopodiaceae sp. (for example sugar beet, fodder beet, swiss chard, beetroot); useful plants and ornamental plants for gardens and wooded areas; including genetically modified versions of each of these plants.

According to a particular embodiment, seeds or plant propagation materials of crop plants which may be treated, or covered, or coated, or dressed, or overspread, or overlaid, in accordance with the compositions of the invention are seeds or plant propagation materials from maize (Zea mays), soybean (Glycine max), cotton (Gossypium hirsutum), wheat (Triticum aestivum), oilseed rape (Brassica napus), rice (Oryza sativa), sunflower (Helianthus annuus), barley (Hordeum vulgare), peas (Pisum sativum), beans (Phaseolus sp., Vicia sp., Vigna sp.).

Plants and plant cultivars, the seeds of which may be treated, or covered, or coated, or dressed, or overspread, or overlaid, according to the invention include plants and plant cultivars which are resistant against one or more biotic stresses, i.e. said plants show a better defense against animal and microbial pests, such as against nematodes, insects, mites, phytopathogenic fungi, bacteria, viruses and/or viroids.

Plants and plant cultivars, the seeds of which may be treated, or covered, or coated, or dressed, or overspread, or overlaid, according to the invention include those plants which are resistant to one or more abiotic stresses. Abiotic stress conditions may include, for example, drought, cold temperature exposure, heat exposure, osmotic stress, flooding, increased soil salinity, increased mineral exposure, ozone exposure, high light exposure, limited availability of nitrogen nutrients, limited availability of phosphorus nutrients, shade avoidance.

Plants and plant cultivars, the seeds of which may be treated, or covered, or coated, or dressed, or overspread, or overlaid, according to the invention include those plants characterized by enhanced yield characteristics. Increased yield in said plants may be the result of, for example, improved plant physiology, growth and development, such as water use efficiency, water retention efficiency, improved nitrogen use, enhanced carbon assimilation, improved photosynthesis, increased germination efficiency and accelerated maturation. Yield may furthermore be affected by improved plant architecture (under stress and non-stress conditions), including but not limited to, early flowering, flowering control for hybrid seed production, seedling vigor, plant size, internode number and distance, root growth, seed size, fruit size, pod size, pod or ear number, seed number per pod or ear, seed mass, enhanced seed filling, reduced seed dispersal, reduced pod dehiscence and lodging resistance. Further yield traits include seed composition, such as carbohydrate content and composition for example cotton or starch, protein content, oil content and composition, nutritional value, reduction in anti-nutritional compounds, improved processability and better storage stability.

Plants and plant cultivars, the seeds of which may be treated, or covered, or coated, or dressed, or overspread, or overlaid, according to the invention include plants and plant cultivars which are hybrid plants that already express the characteristic of heterosis or hybrid vigor which results in generally higher yield, vigor, health and resistance towards biotic and abiotic stresses.

Plants and plant cultivars (obtained by plant biotechnology methods such as genetic engineering or gene editing), the seeds of which may be treated, or covered, or coated, or dressed, or overspread, or overlaid, according to the invention include plants and plant cultivars which are herbicide-tolerant plants, i.e. plants made tolerant to one or more given herbicides. Such plants can be obtained either by genetic transformation, or by selection of plants containing a mutation imparting such herbicide tolerance.

Plants and plant cultivars (obtained by plant biotechnology methods such as genetic engineering or gene editing), the seeds of which may be treated, or covered, or coated, or dressed, or overspread, or overlaid, according to the invention include plants and plant cultivars which are insect-resistant transgenic plants, i.e. plants made resistant to attack by certain target insects. Such plants can be obtained by genetic transformation, or by selection of plants containing a mutation imparting such insect resistance.

Plants and plant cultivars (obtained by plant biotechnology methods such as genetic engineering or gene editing), the seeds of which may be treated, or covered, or coated, or dressed, or overspread, or overlaid, according to the invention include plants and plant cultivars which are disease-resistant transgenic plants, i.e. plants made resistant to attack by certain target pathogens such as fungi, bacteria or viruses. Such plants can be obtained by genetic transformation, or by selection of plants containing a mutation imparting such insect resistance.

Plants and plant cultivars (obtained by plant biotechnology methods such as genetic engineering or gene editing), the seeds of which may be treated, or covered, or coated, or dressed, or overspread, or overlaid, according to the invention include plants and plant cultivars which are tolerant to abiotic stresses. Such plants can be obtained by genetic transformation, or by selection of plants containing a mutation imparting such stress resistance.

Plants and plant cultivars (obtained by plant biotechnology methods such as genetic engineering or gene editing), the seeds of which may be treated, or covered, or coated, or dressed, or overspread, or overlaid, according to the invention include plants and plant cultivars which show altered quantity, quality and/or storage-stability of the harvested product and/or altered properties of specific ingredients of the harvested product.

Plants and plant cultivars (obtained by plant biotechnology methods such as genetic engineering or gene editing), the seeds of which may be treated, or covered, or coated, or dressed, or overspread, or overlaid, according to the invention include plants and plant cultivars, such as cotton plants, with altered fiber characteristics. Such plants can be obtained by genetic transformation, or by selection of plants contain a mutation imparting such altered fiber characteristics.

Plants and plant cultivars (obtained by plant biotechnology methods such as genetic engineering or gene editing), the seeds of which may be treated, or covered, or coated, or dressed, or overspread, or overlaid, according to the invention include plants and plant cultivars, such as oilseed rape or related Brassica plants, with altered oil profile characteristics. Such plants can be obtained by genetic transformation, or by selection of plants contain a mutation imparting such altered oil profile characteristics.

Plants and plant cultivars (obtained by plant biotechnology methods such as genetic engineering or gene editing), the seeds of which may be treated, or covered, or coated, or dressed, or overspread, or overlaid, according to the invention include plants and plant cultivars, such as oilseed rape or related Brassica plants, with altered seed shattering characteristics. Such plants can be obtained by genetic transformation, or by selection of plants contain a mutation imparting such altered seed shattering characteristics and include plants such as oilseed rape plants with delayed or reduced seed shattering.

Plants and plant cultivars (obtained by plant biotechnology methods such as genetic engineering or gene editing), the seeds of which may be treated, or covered, or coated, or dressed, or overspread, or overlaid, according to the invention include plants and plant cultivars, such as Tobacco plants, with altered post-translational protein modification patterns.

### Application to Seeds

The invention is related to the use of a plant propagation material, particularly a seed, treated, or covered, or coated, or dressed, or overspread, or overlaid, with a composition comprising an extract of the pepper plant of the genus Piper.

For example, in one aspect, the invention comprises administering a composition comprising an extract of fruits of the black pepper plant Piper nigrum to seeds, preferably an oleoresin obtained from fruits of the black pepper plant Piper nigrum, wherein the application rate of the composition is at least about one (1) gram per unit of seeds or at least about 5, 10, 15, 20, 25, 30, 40, 45, 50, 75, or 90 grams per unit of seeds. A “unit of seeds” according to the present invention refers to a quantity of seeds corresponding to 50 000 seeds. The method may comprise administering the composition at an application rate of from about one (1) to about 100, from about 5 to about 95, or from about 10 to about 90 grams per unit of seeds. Since the extract may be in liquid form, such as an oleoresin, the application rate may also be expressed as a volume, for example milliliters (ml), per unit of seeds. a person skilled in the art will know how to convert a quantity of the composition expressed in mass into a quantity of such composition expressed in milliliters. For example, when an oleoresin of fruits of the black pepper plant Piper nigrum are used, a possible application rate of the composition may be at least about one (1) ml per unit of seeds or at least about 5, 10, 15, 20, 25, 30, 40, 45, 50, 75, or 90 ml per unit of seeds. It may also be from about one (1) to about 100, from about 5 to about 95, or from about 10 to about 90 ml per unit of seeds. A preferred dose or application rate is about 40 ml of oleoresin per unit of seeds. Other preferred doses or application rates are about 20 ml per unit of seeds, or about 60 ml per unit of seeds.

The application rate may depend on the type of seeds to be treated, and a person skilled in the art would know how to adapt the dose depending on the type of seeds. As guidance, it is proposed that, (i) for corn seeds, the application rate is about 20 to about 100 gram per unit of seeds, about 30 to about 90 gram per unit of seeds, or about 30 to 50 gram per unit of seeds; (ii) for wheat seeds, the application rate is about one (1) to about 20 gram per unit of seeds, about 2 to about 19 gram per unit of seeds, or about 5 to 18 gram per unit of seeds; (iii) for sunflower seeds, the application rate is about one (1) to about 50 gram per unit of seeds, about 2 to about 48 gram per unit of seeds, or about 5 to 45 gram per unit of seeds. Depending on the type of seeds, the person skilled in the art would also know how to convert these proposed application rates to a corresponding application rate per weight of seeds (e.g. kg) and/or to a corresponding application rate per planting/sowing surface (e.g. hectare).

The seed treatment methods described herein can be used in connection with any species of plant and/or the seeds thereof. The methods are used in connection with seeds that are agronomically important. The seed may be a transgenic seed from which a transgenic plant can grow and incorporates a transgenic event that confers, for example, tolerance to a particular herbicide or combination of herbicides, increased disease resistance, enhanced tolerance to insects, drought, stress and/or enhanced yield. The seed may comprise a breeding trait, including for example, in one embodiment a disease tolerant breeding trait. In another embodiment, the seed includes at least one transgenic and breeding trait.

The treatment method may comprise applying a treatment composition to a seed, or other plant propagation material, prior to planting or sowing the seed, so that the planting/sowing operation is simplified. In this manner, seeds, or other plant propagation materials, can be treated, or covered, or coated, or dressed, or overspread, or overlaid, for example, at a central location and then distributed for planting. This may permit a person who plants the seeds to avoid the complexity and effort associated with handling and applying the seed treatment compositions, and to merely plant the treated, or covered, or coated, or dressed, or overspread, or overlaid, seeds in a manner that is conventional for regular untreated seeds.

The treatment composition can be applied to seeds, or other plant propagation material, by any standard seed treatment methodology, including but not limited to mixing in a container (e.g., a bottle or bag), mechanical application, tumbling, spraying, immersion, and solid matrix priming. Seed coating methods and apparatus for their application are disclosed in, for example, U.S. Pat. Nos. 5,918,413, 5,891,246, 5,554,445, 5,389,399, 5,107,787, 5,080,925, 4,759,945 and 4,465,017, among others. Any conventional active or inert material can be used for contacting seeds with the seed treatment composition, such as conventional seed coating materials including but not limited to water-based seed coating materials.

For example, the seed treatment composition can be covered, or coated, or dressed, or overspread, or overlaid, onto a seed by use of solid matrix priming. For example, a quantity of the seed treatment composition can be mixed with a solid matrix material and then the seed can be placed into contact with the solid matrix material for a period to allow the seed treatment composition to be covered, or coated, or dressed, or overspread, or overlaid, to the seed. The seed can then optionally be separated from the solid matrix material and stored or used, or the mixture of solid matrix material plus seed can be stored or planted directly. Non-limiting examples of solid matrix materials which are useful include polyacrylamide, starch, clay, silica, alumina, soil, sand, polyurea, polyacrylate, or any other material capable of absorbing or adsorbing the seed treatment composition for a time and releasing the fungicide(s) of the seed treatment composition into or onto the seed. It is useful to make sure that the seeds treatment composition and the solid matrix material are compatible with each other. For example, the solid matrix material should be chosen so that it can release the seeds treatment composition at a reasonable rate, for example over a period of minutes, hours, days, or weeks.

Imbibition is another method of treating seed with the seed treatment composition. For example, a plant seed can be directly immersed for a period of time in the seed treatment composition. During the period that the seed is immersed, the seed takes up, or imbibes, a portion of the seed treatment composition. Optionally, the mixture of plant seed and the seed treatment composition can be agitated, for example by shaking, rolling, tumbling, or other means. After imbibition, the seed can be separated from the seed treatment composition and optionally dried, for example by patting or air drying.

The seed treatment composition may be applied to the seeds using conventional film techniques and machines, such as fluidized bed techniques, the roller mill method, rotostatic seed treaters, and drum coaters. Other methods, such as spouted beds may also be useful. The seeds may be pre-sized before coating. After or simultaneously to coating, the seeds are optionally dried and then optionally transferred to a sizing machine for sizing. Such procedures are generally known in the art.

If the seed treatment composition is applied to the seed in the form of a coating, the seeds can be coated using a variety of methods known in the art. For example, the coating process can comprise spraying the seed treatment composition onto the seed while agitating the seed in an appropriate piece of equipment such as a tumbler or a pan granulator.

When coating seed on a large scale (for example a commercial scale), the seed coating may be applied using a continuous process. Typically, seed is introduced into the treatment equipment (such as a tumbler, a mixer, or a pan granulator) either by weight or by flow rate. The amount of treatment composition that is introduced into the treatment equipment can vary depending on the seed weight to be coated, surface area of the seed, the concentration of active ingredients in the treatment composition, the desired concentration on the finished seed, and the like. The treatment composition can be applied to the seed by a variety of means, for example by a spray nozzle, a revolving disc or spinning disc. The amount of liquid may be determined by the assay of the formulation and the required rate of active ingredient necessary for efficacy. As the seed falls into the treatment equipment, the seed can be treated (for example by misting or spraying with the seed treatment composition) and passed through the treater under continual movement/tumbling where it can be coated evenly and dried before storage or use.

Alternatively, the seed coating may be applied using a batch process. For example, a known weight of seeds can be introduced into the treatment equipment (such as a tumbler, a mixer, or a pan granulator). A known volume of seed treatment composition can be introduced into the treatment equipment at a rate that allows the seed treatment composition to be applied evenly over the seeds. During the application, the seed can be mixed, for example by spinning or tumbling. The seed can optionally be dried or partially dried during the tumbling operation. After complete coating, the treated sample can be removed to an area for further drying or additional processing, use, or storage.

In a further alternative embodiment, the seed coating may be applied using a semi-batch process that incorporates features from each of the batch process and continuous process embodiments set forth above.

Seeds can be coated in laboratory size commercial treatment equipment such as a tumbler, a mixer, or a pan granulator by introducing a known weight of seeds in the treater, adding the desired amount of seed treatment composition, tumbling or spinning the seed and placing it on a tray to thoroughly dry.

Seeds can also be coated by placing the known amount of seed into a bottleneck or receptacle with a lid. While tumbling, the desired amount of seed treatment composition can be added to the receptacle. The seed is tumbled until it is coated with the treatment composition. After coating, the seed can optionally be dried, for example on a tray.

The treated seeds may also be enveloped with a film overcoating to protect the black pepper coating. Such overcoatings are known in the art and may be applied using conventional fluidized bed and drum seed coating techniques. The overcoatings may be applied to seeds that have been treated with any of the seed treatment techniques described above, including but not limited to solid matrix priming, imbibition, coating, and spraying, or by any other seed treatment technique known in the art.

Application to Plants and/or Soil

In one aspect, a composition comprising an extract of a pepper plant of the genus Piper is supplied to a plant propagation material and/or a seed exogenously. Typically, the composition is applied to the plant propagation material, the seed, and/or the surrounding soil where they are sown through sprays, drips, and/or other forms of liquid application.

In another aspect, the composition comprising an extract of a pepper plant of the genus Piper is directly applied to soil surrounding a seed or other plant propagation material.

The application may be performed using any method or apparatus known in the art, including but not limited to hand sprayer, mechanical sprinkler, or irrigation, including drip irrigation.

For example, the composition according to the invention may be applied to plants and/or soil using a drip irrigation technique. Preferably, the composition is applied directly to the base of the plants or the soil immediately adjacent to the plants. The composition may be applied through existing drip irrigation systems. This procedure is particularly preferred for use in connection with cotton, strawberries, tomatoes, potatoes, vegetables, and ornamental plants.

In another example, the treatment composition may be applied to plants and/or soil using a drench application. Preferably, a sufficient quantity of the treatment composition is applied such that it drains through the soil to the root area of the plants. The drench application technique is particularly preferred for use in connection with turf grasses and crop plants, including corn.

In some embodiments, the composition is applied to soil after planting. In other embodiments, however, the composition may be applied to soil during planting. In other embodiments, however, the composition may be applied to soil before planting. When the composition is applied directly to the soil, it may be applied using any method known in the art. For example, it may be tilled into the soil or applied in furrow.

### Seed, Plant, or Soil Treatment Compositions

Another embodiment of the disclosure is generally related to a treatment composition comprising an extract of a pepper plant of the genus Piper as described herein for use in accordance with the methods for preparation of the treated seeds described herein.

Generally, the compositions described herein can comprise any adjuvants, excipients, or other desirable components known in the art. For example, in some embodiments, the treatment composition further comprises a surfactant.

Examples of anionic surfactants include alkyl sulfates, alcohol sulfates, alcohol ether sulfates, alpha olefin sulfonates, alkylaryl ether sulfates, arylsulfonates, alkylsulfonates, alkylaryl sulfonates, sulfosuccinates, mono- or diphosphate esters of polyalkoxylated alkyl alcohols or alkyl phenols, mono- or disulfosuccinate esters of alcohols or polyalkoxylated alkanols, alcohol ether carboxylates, phenol ether carboxylates. In one embodiment, the surfactant is an alkylaryl sulfonate.

Non-limiting examples of commercially available anionic surfactants include sodium dodecylsulfate (Na-DS, SDS), MORWET D-425 (a sodium salt of alkyl naphthalene sulfonate condensate, available from Akzo Nobel), MORWET D-500 (a sodium salt of alkyl naphthalene sulfonate condensate with a block copolymer, available from Akzo Nobel), sodium dodecylbenzene sulfonic acid (Na-DBSA) (available from Aldrich), diphenyloxide disulfonate, naphthalene formaldehyde condensate, DOWFAX (available from Dow), dihexylsulfosuccinate, and dioctylsulfosuccinate, alkyl naphthalene sulfonate condensates, and salts thereof.

Examples of non-ionic surfactants include sorbitan esters, ethoxylated sorbitan esters, alkoxylated alkylphenols, alkoxylated alcohols, block copolymer ethers, and lanolin derivatives. In accordance with one embodiment, the surfactant comprises an alkylether block copolymer.

Non-limiting examples of commercially available non-ionic surfactants include SPAN 20, SPAN 40, SPAN 80, SPAN 65, and SPAN 85 (available from Aldrich); TWEEN 20, TWEEN 40, TWEEN 60, TWEEN 80, and TWEEN 85 (available from Aldrich); IGEPAL CA-210, IGEPAL CA-520, IGEPAL CA-720, IGEPAL CO-210, IGEPAL CO-520, IGEPAL CO-630, IGEPAL CO-720, IGEPAL CO-890, and IGEPAL DM-970 (available from Aldrich); Triton X-100 (available from Aldrich); BRIJ S10, BRIJ S20, BRIJ 30, BRIJ 52, BRIJ 56, BRIJ 58, BRIJ 72, BRIJ 76, BRIJ 78, BRIJ 92V, BRIJ 97, and BRIJ 98 (available from Aldrich); PLURONIC L-31, PLURONIC L-35, PLURONIC L-61, PLURONIC L-81, PLURONIC L-64, PLURONIC L-121, PLURONIC 10R5, PLURONIC 17R4, and PLURONIC 31R1 (available from Aldrich); Atlas G-5000 and Atlas G-5002L (available from Croda); ATLOX 4912 and ATLOX 4912-SF (available from Croda); and SOLUPLUS (available from BASF), LANEXOL AWS (available from Croda).

Non-limiting examples of cationic surfactants include mono alkyl quaternary amine, fatty acid amide surfactants, amidoamine, imidazoline, and polymeric cationic surfactants.

In some embodiments, the compositions according to the invention comprise a co-solvent in addition to water. Non-limiting examples of co-solvents that can be used include ethyl lactate, methyl soyate/ethyl lactate co-solvent blends (e.g., STEPOSOL, available from Stepan), isopropanol, acetone, 1,2-propanediol, n-alkylpyrrolidones (e.g., the AGSOLEX series, available from ISP), a petroleum based-oil (e.g., AROMATIC series and SOLVESSO series available from Exxon Mobil), isoparaffinic fluids (e.g. ISOPAR series, available from Exxon Mobil), cycloparaffinic fluids (e.g. NAPPAR 6, available from Exxon Mobil), mineral spirits (e.g. VARSOL series available from Exxon Mobil), and mineral oils (e.g., paraffin oil).

Examples of commercially available organic solvents include pentadecane, ISOPAR M, ISOPAR V, and ISOPAR L (available from Exxon Mobil).

In some embodiments, the treatment composition according to the invention may be formulated, mixed in a seed treater tank, combined on the seed by overcoating, or combined with one or more additional active ingredients. The additional active ingredients may comprise, for example, a pesticide or a biological agent. In some embodiments, the treatment composition comprises a composition according to the invention, i.e. an extract of a pepper plant of the genus Piper, and another pesticide, for example a nematicide, insecticide, fungicide, and/or herbicide. In some embodiments, the treatment composition comprises a composition according to the invention, i.e. an extract of a pepper plant of the genus Piper, and a biological agent.

Non-limiting examples of insecticides and nematicides include carbamates, diamides, macrocyclic lactones, neonicotinoids, organophosphates, phenylpyrazoles, pyrethrins, spinosyns, synthetic pyrethroids, tetronic and tetramic acids. In another embodiment, insecticides and nematicides include abamectin, aldicarb, aldoxycarb, bifenthrin, carbofuran, chlorantraniliprole, clothianidin, cyantraniliprole, cyfluthrin, cyhalothrin, cypermethrin, deltamethrin, dinotefuran, emamectin, ethiprole, fenamiphos, fipronil, flubendiamide, fosthiazate, imidacloprid, ivermectin, lambda-cyhalothrin, milbemectin, tioxazafen, nitenpyram, oxamyl, permethrin, spinetoram, spinosad, spirodichlofen, spirotetramat, tefluthrin, thiacloprid, thiamethoxam, and thiodicarb.

In one embodiment, the insectide may be selected from the group consisting of clothianidin, thiamethoxam, tioxazafen, imidacloprid and combinations thereof.

Non-limiting examples of useful fungicides include aromatic hydrocarbons, benzimidazoles, benzothiadiazole, carboxamides, carboxylic acid amides, morpholines, phenylamides, phosphonates, quinone outside inhibitors (e.g. strobilurins), thiazolidines, thiophanates, thiophene carboxamides, and triazoles, Non-limiting examples of fungicides include acibenzolar-S-methyl, azoxystrobin, benalaxyl, bixafen, boscalid, carbendazim, chlorothalonil, cyproconazole, dimethomorph, epoxiconazole, fludioxonil, fluopyram, flutianil, flutolanil, fluxapyroxad, fosetyl-Al, ipconazole, isopyrazam, kresoxim-methyl, mefenoxam, metalaxyl, metconazole, myclobutanil, orysastrobin, penflufen, penthiopyrad, picoxystrobin, propiconazole, pyraclostrobin, sedaxane, silthiofam, tebuconazole, thifluzamide, thiophanate, tolclofos-methyl, trifloxystrobin, and triticonazole.

In one embodiment, the fungicide may be selected from the group consisting of ipconazole, metalaxyl, trifloxystrobin, pyraclostrobin, fluxapyroxad, sedaxane, fluopyram, mefenoxam, penflufen, azoxystrobin and combinations thereof.

Non-limiting examples of herbicides include ACCase inhibitors, acetanilides, AHAS inhibitors, carotenoid biosynthesis inhibitors, EPSPS inhibitors, glutamine synthetase inhibitors, PPO inhibitors, PS II inhibitors, and synthetic auxins. Non-limiting examples of herbicides include acetochlor, clethodim, dicamba, flumioxazin, fomesafen, glyphosate, glufosinate, mesotrione, quizalofop, saflufenacil, sulcotrione, 2,4-D, trifloxysulfuron, and halosulfuron.

In one embodiment, the herbicide may be selected from the group consisting of acetochlor, dicamba, glyphosate and combinations thereof.

Additional actives may also comprise substances such as, biological agents for pest control, microbial extracts, plant growth activators or plant defense agents. Non-limiting examples of biological agents include bacteria, fungi, beneficial nematodes, and viruses.

In certain embodiments, the biological agent can be a bacterium of the genus Actinomycetes, Agrobacterium, Arthrobacter, Alcaligenes, Aureobacterium, Azobacter, Bacillus, Beijerinckia, Brevibacillus, Burkholderia, Chromobacterium, Clostridium, Clavibacter, Comamonas, Corynebacterium, Curtobacterium, Enterobacter, Flavobacterium, Gluconobacter, Hydrogenophaga, Klebsiella, Methylobacterium, Paenibacillus, Pasteuria, Photorhabdus, Phyllobacterium, Pseudomonas, Rhizobia, Serratia, Sphingobacterium, Stenotrophomonas, Variovorax, and Xenorhabdus. In particular embodiments the bacteria is selected from the group consisting of Bacillus amyloliquefaciens, Bacillus cereus, Bacillus firmus, Bacillus, lichenformis, Bacillus pumilus, Bacillus sphaericus, Bacillus subtilis, Bacillus thuringiensis, Chromobacterium suttsuga, Pasteuria penetrans, Pasteuria usage, and Pseudomonas fluorescens.

In certain embodiments the biological agent can be a fungus of the genus Alternaria, Ampelomyces, Aspergillus, Aureobasidium, Beauveria, Colletotrichum, Coniothyrium, Gliocladium, Metarhizium, Muscodor, Paecilomyces, Bradyrhizobia, Trichoderma, Typhula, Ulocladium, and Verticillium. In another embodiment the fungus is Beauveria bassiana, Coniothyrium minitans, Gliocladium virens, Muscodor albus, Paecilomyces lilacinus, or Trichoderma polysporum.

In further embodiments the biological agents can be plant growth activators or plant defense agents including, but not limited to harpin, Reynoutria sachalinensis, jasmonate, lipochitooligosaccharides, salicylic acid and isoflavones. In another embodiment, the biological agent may be selected from the group consisting of Bacillus firmus.

The method herein described may also be expressed as a use of a composition comprising an extract of a pepper plant of the genus Piper for increasing the yield of crop plants, wherein the plant propagation material from which such crop plant is being grown is treated, or covered, or coated, or dressed, or overspread, or overlaid, with such composition.

The invention further encompasses a method for stimulating the growth of plants characterized in that the plant propagation material from which such plant is being grown is covered with a composition comprising an extract of a pepper plant of the genus Piper.

In another embodiment, the invention encompasses a method for increasing the growth of plants characterized in that the plant propagation material from which such plant is being grown is covered with a composition comprising an extract of a pepper plant of the genus Piper.

Having described the embodiments in detail, it will be apparent that modifications and variations of the disclosure are possible without departing from the scope of the appended claims.

### EXAMPLES

The following non-limiting examples are provided for further illustration.

### Example 1: Preparation of Plant Extract Compositions

Different compositions according to the invention have been prepared by extraction from selected plant materials.

An extract of dried fruits of the pepper plant Piper nigrum, also known as peppercorn, is prepared in a two-steps extraction. The crushed peppercorns are first subjected to steam distillation, so as to produce a distillate. Then, in a second extraction step, the crushed peppercorns that have been subjected to steam distillation are then subjected to a solvent extraction, using a solvent mixture comprising ethylacetate, acetone and hexane. After sufficient extraction time, the solvents are then evaporated to yield a semi-solid extract known as resin. An oleoresin is then formed by mixing the distillate with the resin so as to obtain an oleoresin containing 38% of piperine and 18% of volatile oils.

### Example 2: Effect on Yield of Maize Plants, Zea Mays

In order to measure the effect of the extract of Piper nigrum described in Example 1 on the yield of certain crop plants, field trials have been conducted with the maize plant, Zea Mays.

Six similar field trials have been carried out in four different countries (two in Italia, one in Romania, two in Bulgaria, and one in Spain).
Each field trial has been performed by comparing untreated maize seeds (controls) with maize seeds treated prior to planting/sowing with a formulated composition of the black pepper oleoresin of Example 1 (comprising 40% of oleoresin), tested at two different doses:
Dose 1: quantity of formulated composition corresponding to 40.5 ml black pepper oleoresin/50 000 seeds
Dose 2: quantity of formulated composition corresponding to 60.76 ml black pepper oleoresin/50 000 seeds
   Trials were carried out in 4 replicates per treatment modality, each with 100 seeds.
   All seeds, including the untreated control seeds, have also been treated with fungicides, herbicides and insecticides. Any observed effect on yield therefore cannot be attributed to any effect of the oleoresin on pathogens, weeds or insects.
   All field trials have also been monitored for attacks by birds, so as to retain only those trials which have not suffered any attacks by bird. Any observed effect on yield therefore cannot be attributed to the known bird repellent effect of the oleoresin.
   For assessing the yield data, maize ears have been harvested and weighted for each trial.
   The results obtained are reported in Table 1, as a percentage relative to the untreated control representing 100%.

TABLE 1
Relative yield and yield increase of maize plants
treated with an extract of Piper nigrum

| | | | | | Relative | Relative |
|---|---|---|---|---|---|---|
| | | | | | yield | yield |
| Trial | Maize | | | | increase | increase |
| No. | variety | Untreated | Dose 1 | Dose 2 | Dose 1 (%) | Dose 2 (%) |
| 1 | P1916 | 100 | 113.04 | 111.24 | 13.04 | 11.24 |
| 2 | DKC6092 | 100 | 105.49 | 105.02 | 5.49 | 5.02 |
| 3 | ONDINA | 100 | 105.27 | 99.91 | 5.27 | −0.09 |
| 4 | KX0023 | 100 | 104.73 | 107 | 4.73 | 7 |
| 5 | EU4661 | 100 | 103.05 | 105.22 | 3.05 | 5.22 |
| 6 | DKC 4621 | 100 | 97.15 | 101.71 | −2.85 | 1.71 |

| | | |
|---|---|---|
| Average | 4.8% | 5% |

These results clearly show that, on average, the treatments with the extract of Piper nigrum provide a yield increase of about 5%, which represents a very significant increase for growers. The effect could be observed at both doses used.

### Example 3: Effect on Early Plant Establishment of Maize Plants, Zea Mays

The test is performed under greenhouse conditions.
Corn seeds (var. DKC6664) were professionally treated with base fungicide only (RedigoM FS120 with 15 ml/until, specification no.: 102000022351; referred to as “untreated”) or in addition to the base fungicide with 101.25 ml/unit of formulated Black Pepper Oleoresin (BPO ES 400, specification no.: 102000053905; referred to as “BPO-treated).
Five seeds per treatment were each sown in a total of 3 cassettes (68*15*5 cm) containing a 1:1 mix of field soil and sand (all hot-steamed, coarsely sieved, summing up to 15 plants per treatment). The plants were grown at 22° C. temperature in 2 different greenhouse chambers. The relative humidity was constant at approx. 80% and artificial light switched on from 7 h to 19 h (day/night interval of 12 h). Pots were inspected once a day for adding the very same amount of water per each cassette. After 20 and 25 days, respectively, the plants were carefully dug up, cleaned, and divided into 2 parts, the roots and the shoots. Each single part was measured for length and fresh weight.
Table 2 below clearly shows that the BPO treated corn seed demonstrated an increased length and fresh weight early after sowing.

TABLE 2
Mean (±standard error) based on 3 × 5 plants for each
treatment (untreated vs. BPO treated) for different evaluations:
shoot and root length as well as shoot and root fresh weight.

| | | | SHOOT | ROOT |
|---|---|---|---|---|
| | SHOOT | ROOT | FRESH | FRESH |
| | LENGTH | LENGTH | WEIGTH | WEIGTH |
| | [CM] | [CM] | [G] | [G] |
| UNTREATED | 32.87 ± 0.64 | 60.27 ± 0.88 | 2.32 ± 0.08 | 2.11 ± 0.05 |
| BPO- | 38.87 ± 0.26 | 60.53 ± 0.87 | 3.15 ± 0.07 | 2.47 ± 0.04 |
| TREATED | | | | |
| % DIFFENCE | +18.26% | +0.44% | +35.9% | +16.81% |
| P-VALUE* | 0.01 | 0.37 | 0.03 | 0.14 |

*A Mann-Whitney U test (sometimes referred to as a Wilcoxon-Mann-Whitney test) was used at alpha level 5% to compare differences between samples of treated vs. untreated soybean seeds, because sample distributions were not normally distributed and sample sizes was small (n < 30).

This test provides a possible explanation about the contribution of the extract of Piper nigrum to the increased yield observed in Example 2.

1. A method for increasing a yield of crop plants,
the method comprising:
obtaining plant propagation material from a crop plant of the crop plants; and
covering the plant propagation material with a composition, the composition comprising an extract of a pepper plant of genus Piper.

2. The method according to claim 1, wherein the composition comprises an extract of plant species Piper nigrum.

3. The method according to claim 2, wherein the composition comprises an extract of fruits of the plant Piper nigrum.

4. The method according to claim 1, wherein the extract is a solvent extract.

5. The method according to claim 1, wherein the extract is an oleoresin.

6. The method according to claim 1, wherein the plant propagation material is a seed.

7. The method according to claim 1, wherein the plant propagation material is a plant part for vegetative propagation.

8. The method according to claim 1, further comprising a step of planting or sowing at least one the plant propagation material of the crop plant.

9. The method according to claim 1, further comprising growing the crop plant until maturity of its harvestable plant material.

10. The method according to claim 9, wherein the crop plant is grown in an open field.

11. The method according to claim 9, wherein the crop plant is grown in a greenhouse, a glasshouse or any building suitable for growing crops.

12. The method according to claim 9, wherein the crop plant is grown in hydroponic conditions.

13. The method according to claim 1, wherein an increase in the yield is comprised between 1% and 20%.

14. The method according to claim 13, wherein an increase in the yield is comprised between 1% and 10%.

15. The method according to claim 14, wherein an increase in the yield is about 5%.
